(19) United States
(12) Patent Application Publication
(10) Pub. No.: US 2025/0307779 A1
(43) Pub. Date: Oct. 2, 2025

(54) METHODS AND SYSTEMS FOR SERVICE EXCHANGE IN DORMANT AND UNTAPPED LABOR MARKETS

(71) Applicant: PRENDE INC, Miami, FL (US)

(72) Inventor: Marcela Carranza, Miami, FL (US)

(21) Appl. No.: 19/091,657

(22) Filed: Mar. 26, 2025

Related U.S. Application Data
(60) Provisional application No. 63/571,336, filed on Mar. 28, 2024.

(51) Int. Cl. G06Q 10/1053; G06Q 10/0631

(52) U.S. Cl. CPC G06Q 10/1053; G06Q 10/063112

(57) ABSTRACT

Various embodiments of the present disclosure provide a method for service exchange in dormant and untapped labor markets. The method performed by a server system begins with candidate enrollment and form submission, capturing comprehensive information. The server system processes this data through mental health, personality, attribute, competency, or knowledge assessments. A resulting CTP is stored in a database. A gap analysis compares the CTP to a pre-defined Success Talent Profile (STP), identifying deviations. Based on these deviations, candidates are classified: those with skill/knowledge gaps are designated for employment matching, while those with core competency gaps receive targeted training. The server system then matches employable candidates with businesses and training-eligible candidates with service providers, optimizing labor market integration.

### TECHNICAL FIELD

The present disclosure relates to the field of employment facilitation and, more particularly, to methods and systems for talent acquisition, skill matching, and service exchange in dormant and untapped labor markets.

### BACKGROUND

People belonging to the dormant and untapped labor markets often encounter significant barriers to accessing employment opportunities. For example, such people include individuals who may have historically faced barriers to employment due to various circumstances such as incarceration, hospitalization, or disabilities. Traditional hiring processes may inadvertently exclude such individuals due to their physical location, social stigmas, or systemic challenges. As a result, such people face having no access to growth, in addition to, perpetuating cycles of unemployment, poverty, and dependence on social support systems. Additionally, limited access to traditional job markets may perpetuate cycles of drug abuse, involvement in criminal activities, heightened poverty rates, and deteriorating physical and mental health of such individuals. Further, despite the potential talent pool present in these sectors, such individuals may struggle to effectively showcase their skills and qualifications to potential employers.

Thus, there exists a technological need for a system and method to bridge the gap between such individuals and employers.

### SUMMARY

Various embodiments of the present disclosure provide methods and systems for service exchange in dormant and untapped labor markets. The methods and the systems are designed to empower marginalized communities by providing a structured pathway to employment. The employment is achieved by directly connecting businesses with potential candidates, identifying and bridging skill gaps through targeted training, and fostering a supportive network involving various stakeholders. The methods and the systems also streamline communication, ensure fair financial compensation, and incorporate feedback mechanisms for continuous improvement, ultimately promoting economic empowerment and sustainable employment.

According to an aspect of the present disclosure, there is provided a method for service exchange in dormant and untapped labor markets. The method performed by a server system includes receiving candidate enrollment requests and generating detailed candidate talent profiles (CTPs) through comprehensive assessments of mental health, personality, attributes, competencies, and knowledge. The server system then compares these CTPs to predefined success talent profiles (STPs), performing gap analyses to identify deviations. Based on the nature of these deviations, candidates are either designated for direct employment matching with business entities if skill or knowledge gaps are determined or referred to service providers for training and competency development if core competency gaps are determined. This process ensures effective matching and targeted development within the labor markets.

According to another aspect of the present disclosure, there is provided a server system for service exchange in dormant and untapped labor markets. The server system includes a memory unit including machine-readable instructions. The server system further includes a processor operably connected to the memory unit. The processor is configured to execute the machine-readable instructions. The machine-readable instructions when executed by the processor, cause the server system to receive candidate enrollment requests, render candidate forms, and process candidate information through comprehensive assessments. The system generates and stores candidate talent profiles (CTPs), compares them to predefined success talent profiles (STPs), performs gap analyses, and confirms deviations. Based on determined deviations, the server system is caused to designate candidates for either direct employment matching with business entities, when skill or knowledge gaps are determined, or service provider matching for training and competency development, when core competency gaps are determined, effectively managing and matching candidates within these dormant labor markets.

According to another aspect of the preset disclosure, there is provided a non-transitory computer-readable storage medium including machine-readable instructions that, when executed by a processor of a server system, cause the server system to perform a method. The method includes receiving candidate enrollment requests and generating detailed candidate talent profiles (CTPs) through comprehensive assessments of mental health, personality, attributes, competencies, and knowledge. The server system then compares these CTPs to predefined success talent profiles (STPs), performing gap analyses to identify deviations. Based on the nature of these deviations, candidates are either designated for direct employment matching with business entities if skill or knowledge gaps are determined, or referred to service providers for training and competency development if core competency gaps are determined. This process ensures effective matching and targeted development within the labor markets.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some embodiments of the present disclosure;

FIG. 2 illustrates a simplified block diagram of a server system, in accordance with an embodiment of the present disclosure;

FIG. 3A illustrates a method for generating a CTP of a candidate, in accordance with an embodiment of the present disclosure;

FIG. 3B illustrates a method for performing gap analysis on the CTP of the candidate, in accordance with an embodiment of the present disclosure;

FIGS. 4A-4I illustrate Graphic User Interfaces (GUI) for a business entity, generated by a service exchange application, to be displayed on a first device, in accordance with several embodiments of the present disclosure;

FIGS. 5A and 5B illustrate GUIs for a candidate, generated by the service exchange application, in accordance with several embodiments of the present disclosure;

FIGS. 6A and 6B illustrate GUIs for a maturation service, generated by the service exchange application, in accordance with several embodiments of the present disclosure;

FIGS. 7A and 7B illustrate GUIs for a candidate institution, generated by the service exchange application, in accordance with several embodiments of the present disclosure;

FIGS. 8A and 8B illustrate GUIs for a Non-Governmental Organization (NGO), generated by the service exchange application, in accordance with several embodiments of the present disclosure;

FIG. 9 illustrates a method for service exchange in dormant and untapped labor markets, in accordance with an embodiment of the present disclosure; and

FIG. 10 shows a simplified block diagram of a computing device capable of implementing the various embodiments of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The phrases “dormant and untapped labor markets” and “underserved sectors”, used interchangeably throughout the description refer to groups of people within a society who face systemic disadvantages, and limited access to resources and opportunities, often leading to their social, economic, or exclusion. These sectors typically experience a lack of access to progress through training, education, and employment, and face barriers that hinder their full participation in various aspects of community life. Some of the common examples of dormant and untapped labor markets include the incarcerated, and any person that due to their physical location or lack of resources, has no access to develop and market their skills for profit.

The phrases “job opportunities”, “employment opportunities”, “job offers”, and “work opportunities”, used interchangeably throughout the description refer to the chances or possibilities for employment that are available to individuals within a certain area, industry, or organization. These opportunities could be for various types of employment, including full-time, part-time, temporary, contract-based, or freelance positions.

The phrase “Non-Governmental Organization (NGO)” refers to independent, typically non-profit groups formed by citizens to address a variety of social, environmental, and humanitarian issues. Some of the roles that NGOs play include advocacy, service delivery, and public awareness campaigns. While NGOs may receive funding from governments, foundations, or private donors, their independence allows them to pursue their missions without direct governmental influence.

### Overview

Various embodiments of the present disclosure provide a method, a server system, and a non-transitory computer-readable storage medium for facilitating service exchange, particularly focusing on dormant and untapped labor markets. The process begins with the server system receiving a request for a candidate enrolling in a service exchange application. The server system then renders a candidate form to collect detailed candidate information, which is subsequently processed through various assessments, including mental health, personality, personal attributes, competency, and knowledge assessments. Based on this processed information, a Candidate Talent Profile (CTP) is generated and stored in a database.

Further, the CTP is compared with a predefined Success Talent Profile (STP) to identify any deviations. A gap analysis is performed to pinpoint specific gaps or deviations in the candidate's profile. If a potential gap or deviation is confirmed, the system assigns determines whether it primarily relates to skills and knowledge, or core competencies. If the gap is related to skills and knowledge, the candidate is deemed eligible for employment and matched with suitable business entities. Conversely, if the gap is related to core competencies, the candidate will be designated for training services and matched with relevant service providers prior to being eligible for employment.

The described embodiments offer several potential advantages, particularly in the context of accessing dormant and untapped labor markets. By incorporating mental health, personality, personal attributes, competency, and knowledge assessments, the embodiments provide a holistic view of each candidate. This allows for a more accurate evaluation of their potential, going beyond traditional resume-based assessments. The comparison of the Candidate Talent Profile (CTP) with a Success Talent Profile (STP) and the subsequent gap analysis helps identify specific areas where candidates need improvement. This enables targeted training and development. By matching candidates with business entities or service providers based on their assessed skills and competencies, the embodiments increase the likelihood of successful placements. This can lead to higher job satisfaction and reduced turnover. The embodiments' focus on dormant and untapped labor markets allows businesses to access a wider pool of potential candidates, including individuals who may have been overlooked by traditional recruitment methods.

By identifying and addressing core competency gaps through training services, the embodiments help candidates develop the skills they need to succeed. This can lead to increased employability and long-term career growth. By correctly identifying if a candidate needs employment matching, or service/training matching, the embodiments allow for the correct resource allocation to the candidate. The reliance on data and analytics provides businesses and service providers with valuable insights into candidate strengths and weaknesses. This can inform hiring decisions and training programs. By utilizing standardized assessments, the embodiments can potentially reduce bias in the hiring process, leading to more equitable outcomes. Automating the assessment and matching process can save time and resources for both businesses and candidates. The creation of a comprehensive Candidate Talent Profile (CTP) provides a detailed record of each candidate's skills and abilities, which can be used for future employment or training opportunities.

### Description of Figures

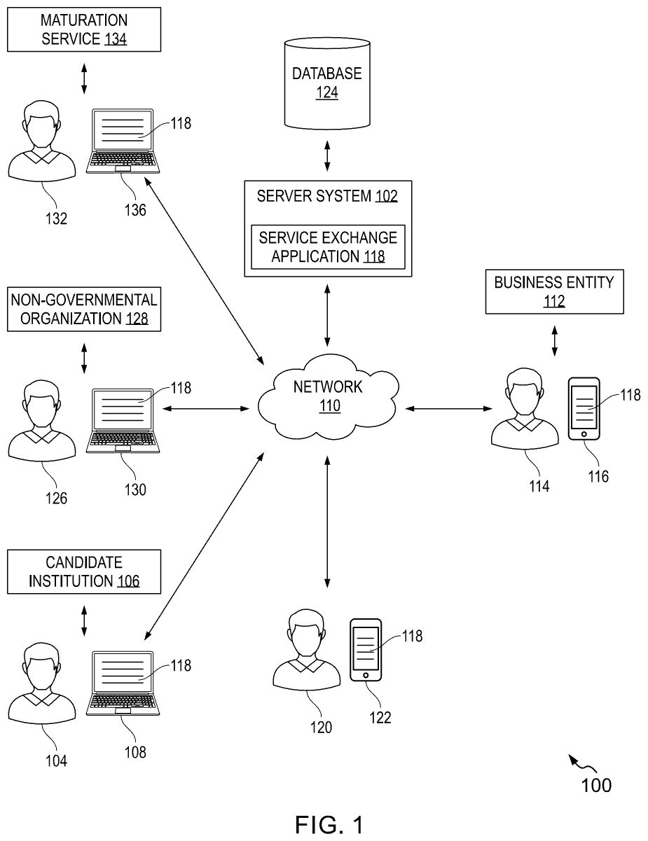

Various example embodiments of the present disclosure are described hereinafter with reference to FIGS. 1 to 10.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, providing service exchange opportunities for the marginalized sector.

The environment 100 generally includes a first device 116 associated with a business entity 112. The first device 116 may also be interchangeably referred to as a business entity device 116. In several embodiments, the first device 116 may be selected from a group consisting of a smartphone, a notebook PC, a tablet PC, a desktop PC, a wearable device, a smart device such as a smart TV or a smart appliance, and the like. The business entity 112 is envisaged to provide employment opportunities for individuals in the dormant and untapped labor markets, as will be discussed in the following discussion. The business entity 112 in that regard may be any business willing to extend employment and services on the platform as ways of practicing a new way of corporate philanthropy where the talent they hire remains responsible for the NGO donations from the fruit of their work. The business entity 112 may be represented by a first user 114 associated with the first device 116.

The environment 100 further includes a candidate device 122 associated with a candidate 120 seeking employment with the business entity 112. The candidate device 122 may be selected from a group consisting of a smartphone, a notebook PC, a tablet PC, a desktop PC, a wearable device, a smart device such as a smart TV or a smart appliance, and the like. The candidate 120 is envisaged to be an individual from the aforementioned one or more dormant and untapped labor markets of society. Furthermore, the environment 100 includes a candidate institution device 108 associated with a candidate institution 106. The candidate institution device 108 may be selected from a group consisting of a smartphone, a notebook PC, a tablet PC, a desktop PC, a wearable device, a smart device such as a smart TV or a smart appliance, and the like. The candidate institution 106 is represented by a candidate institution representative 104. The candidate 120 envisaged to be represented by the candidate institution 106 for acquiring employment with the business entity 112. In that regard, the candidate institution 106 includes correctional facilities (e.g., prisons, jails, detention centers, etc.), healthcare institutions (e.g., hospitals, clinics, etc.), assisted living facilities and nursing facilities, homeless shelter facilities, etc.

The environment 100 further includes an NGO device 130 associated with an NGO 128. The NGO device 130 may be selected from a group consisting of a smartphone, a notebook PC, a tablet PC, a desktop PC, a wearable device, a smart device such as a smart TV or a smart appliance, and the like. The NGO 128 may be represented by an NGO representative 126. Furthermore, the NGO 128 is a beneficiary of a percentage of the earnings of the candidate 120. The environment 100 further includes a maturation service device 136 associated with a maturation service 134. The maturation service device 136 may be selected from a group consisting of a smartphone, a notebook PC, a tablet PC, a desktop PC, a wearable device, a smart device such as a smart TV or a smart appliance, and the like. Furthermore, the maturation service 134 is represented by a maturation service representative 132.

The maturation service 134 is envisaged to provide services such as competency modeling, organizational assessments, competency framework development, change management support, talent management strategy development, training effectiveness evaluation, and Return on Investment (ROI) analysis for the business entity 112. Furthermore, for the candidate 120, the maturation service 134 may offer services such as skill gap analysis, individual assessments, customized training, workshops and seminars, e-learning and online courses, mentoring and coaching, on-the-job training, competency progress tracking, development of soft skills such as communication, teamwork, leadership, and emotional intelligence, spiritual, entertainment, fitness, etc.

For the purposes of the disclosure, the business entity device 116 is referred to as the first device 116 associated with the first user 114. The business entity 112 has been referred to as a first stakeholder 112. The candidate device 122, the candidate institution device 108, and the NGO device 130 have been referred to as one or more second devices 108, 122, or 130. Furthermore, the candidate 120, the candidate institution representative 104, and the NGO representative 126 have been referred to as one or more second users 104, 120, or 126. Similarly, the candidate 120, the candidate institution 106, and the NGO 128 have been collectively referred to as one or more second stakeholders 106, 120, or 128.

The environment 100 further includes a server system 102 (also referred to as “the system 102”) hosting a service exchange application 118. The server system 102 is embodied in at least one computing device in communication with a network 110 and/or embodied in at least one non-transitory machine-readable media. For example, the server system 102 may be deployed as a standalone server or can be implemented in the cloud as software as a service (SaaS). The server system 102 provides or hosts the service exchange application 118 (interchangeably referred to as “software application 118”) for enabling service exchange in dormant and untapped labor markets amongst the first stakeholder 112, the one or more second stakeholders 106, 120, or 128, or the maturation service 134. The software application 118 is a set of machine-readable codes configured to provide user interfaces (UIs) enabling the first stakeholder 112, second stakeholders 106, 120, or 128, or the maturation service 134 to connect and generate and provide employment opportunities for individuals of the dormant and untapped labor markets. Furthermore, in several embodiments, individual instances of the software application 118 are accessible to the first device 116, the one or more second devices 108, 122, or 130, or the maturation service device 136.

For example, the software application 118 may be a mobile application, a desktop application, a website, or a plugin in a third-party application (such as a browser application, a word processor application, a spreadsheet application, and the like). Furthermore, a third-party application may be any existing application facilitating the execution of tasks similar to that performed by the server system 102. In some embodiments, the software application 118 can be implemented as operating system extensions, modules, plugins, and the like. This enables the first user 114, the one or more second users 104, 120, or 126, or the maturation service representative 132 to be able to access the server system 102 on the first device 116, the one or more second devices 108, 122, or 130, or the maturation service device 136, respectively. In another embodiment, the software application 118 may be factory-installed on the first device 116, the one or more second devices 108, 122, or 130, or the maturation service device 136. However, even during factory installation, it is envisaged that the software application 118 is provided by the sever system 102 for download and installation in the first device 116, the one or more second devices 108, 122, or 130, or the maturation service device 136.

In addition to accessing the server system 102, the individual instances of the software application 118 allow the first device 116, the one or more second devices 108, 122, or 130, or the maturation service device 136 to configure an online professional network of users where the first user 114, the one or more second users 104, 120, or 126, or the maturation service representative 132 can communicate with each other and exchange information, documents, media files, etc. amongst the first device 116, the one or more second devices 108, 122, or 130, or the maturation service device 136 and the server system 102. In several embodiments, any one or more of the first device 116, the one or more second devices 108, 122, or 130, or the maturation service device 136 can replace the server system 102 to enable peer-to-peer social networking between the first device 116, the one or more second devices 108, 122, or 130, or the maturation service device 136.

Further, in several alternate embodiments, the software application 118 may be operative in a cloud infrastructure, or the software application 118 may be executed within or as a virtual machine (VM), a virtual server, or a container that may be managed in the cloud infrastructure. In the cloud-based infrastructure, software application 118 may not need to be installed locally in the first device 116, the one or more second devices 108, 122, or 130, or the maturation service device 136 to configure the online professional network. In several embodiments, the cloud-based implementation of the software application 118 may follow a single tenancy where individual instances of the software application 118 may be installed and assigned to the first user 114, the one or more second users 104, 120, or 126, or the maturation service representative 132 accessing the cloud infrastructure through the first device 116, the one or more second devices 108, 122, or 130, or the maturation service device 136, respectively.

In several alternate embodiments, the software application 118 may be configured as a multi-tenant application where at least one instance of the software application 118 installed with the server system 102 may allow the online professional network to be configured using multi-tenancy. In such a scenario as well, the online professional network of users may be configured, where the first user 114, the one or more second users 104, 120, or 126, or the maturation service representative 132 can communicate with each other and exchange information, documents, media files, etc. amongst the first device 116, the one or more second devices 108, 122, or 130, the maturation service device 136 and the server system 102.

In one example, the server system 102 enables service exchange in dormant and untapped labor markets. In that regard, the system 102 receives an enrollment request for a candidate to participate in the service exchange application 118. The enrollment request may be received from the one or more second devices 108, 122, or 130. Furthermore, the system 102 renders a candidate form on a display of a computing device, such as the one or more second devices 108, 122, or 130. The candidate form is configured to capture candidate information. The system 102 then processes the candidate information. The processing of candidate information may include mental health and personality assessments, personal attribute assessments, competency assessments, and knowledge assessments.

The system 102 then generates a candidate talent profile (CTP) based on the processed candidate information. The system 102 then stores the CTP in a database 124 in communication with the system 102. The system 102 analyzes the CTP using AI/ML algorithms, comparing the CTP to a pre-stored Success Talent Profile (STP) to identify gaps. If gaps are job-specific, the CTP is made available to businesses for recruitment. If gaps are related to other areas like mental health, the system 102 facilitates targeted training. Furthermore, the system 120 matches candidates with businesses based on skills and job requirements.

In several embodiments, the system 102 also enables communication between the first device 116 and the one or more second devices 108, 122, or 130 for exchange of one or more of text messages, multimedia messages, audio calling, video calling, or contracts. In several embodiments, the system 102 further enables the transfer of one or more financial instruments between the first device 116 and the one or more second devices 108, 122, or 130. The transfer of one or more financial instruments may be enabled in response to partial or entire completion of a job associated with the job opening, by the candidate 120. The one or more financial instruments, for example, may be selected from a group consisting of fiat currency, cryptocurrency, bonds, or stock options, and may be shared amongst the one or more second stakeholders 106, 120, or 128, depending upon predetermined criteria.

It should be noted that the number of users and electronic devices described herein are only used for exemplary purposes and do not limit the scope of the disclosure. The disclosure applies to any finite number of individuals or groups of users acting as the one or more second users, and any finite number of individuals or groups of users acting as the first user.

The database 124 may be configured in one or more storage devices with non-volatile memory such as flash memory, Erasable Programmable Read-Only Memory (EPROM), Electrically Erasable Programmable Read-Only Memory (EEPROM) located at a centralized location such as a cloud computing facility, or may be distributed database configured in several storage devices across several locations for redundancy. In several embodiments, the database 124 may be maintained in a Network Associated Storage (NAS) or a Storage Area Network (SAN). The database 124 may be configured to store user data such as usernames, passwords, names, contact details, profile pictures, and other details provided by the first user 114, the one or more second users 104, 120, or 126, or the maturation service representative 132. Furthermore, the database 124 may store user-generated content such as posts, comments, photos, videos, links, and other content shared by the first user 114, the one or more second users 104, 120, or 126, or the maturation service representative 132.

The database 124 may also store relationships and connections such as followers, groups, and communities. The database 124 may further be configured to store data on user interactions with content, such as shares, feedback, comments, and reactions. Furthermore, activity logs including logins, posts, profile updates, and other actions may also be stored in the database 124. Also, stored in the database 124 may be user preferences for privacy, notifications, and other settings. The database 124 may also store information related to the online professional network as well, which may further include features, functionalities, content, and administrative data such as data related to user management, content moderation, and other administrative tasks.

It is to be noted here that the database 124 is a representative term for one or more instances of one or more types of databases associated with the server system 102. The types of databases represented by the database 124 may include relational databases, document databases, graph databases, key-value databases, and the like. Several combinations of different kinds of databases may be used for managing the online professional network. For example, relational databases are ideal for information that has a standardized, consistent structure. Examples of such information may include first name, last name, phone number, address, etc. Examples of relational databases include MySQL, PostgreSQL, and Microsoft SQL Server. A document database stores unstructured data that does not fit into traditional relational databases. Document databases may be useful for user-generated social data like user chat messages, comments, photos, and videos. Examples of document databases include MongoDB, Firebase Realtime Database, and CouchDB.

A graph database stores data as connections. Graph databases may be useful for data that has complex relationships, e.g., connections, followers, feedback, and shares on the online professional network. The graph databases would enable the generation of recommendations for new connections, pages, or services. Examples of graph databases include NebulaGraph, Neo4j, ArangoDB, and OrientDB. A key value database stores data that has unique identifiers, e.g., time stamps. In the context of the online professional network or the software application 118, these identifiers or keys can be login sessions or notification preferences. Examples of key-value databases include Redis, DynamoDB, and Memcached.

The devices and systems depicted in the environment 100 may communicate with each other through a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, any future communication protocol, or any combination thereof. The network 110 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 110 may include multiple different networks, such as a private network made accessible by the first device 116, the one or more second devices 108, 122, or 130, the maturation service device 136, the server system 102, and the database 124 separately, and/or a public network (e.g., the Internet) through which the first device 116, the one or more second devices 108, 122, or 130, the maturation service device 136, the server system 102, and the database 124 may communicate.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the environment 100 may perform one or more functions described as being performed by another set of systems or another set of devices of the environment 100.

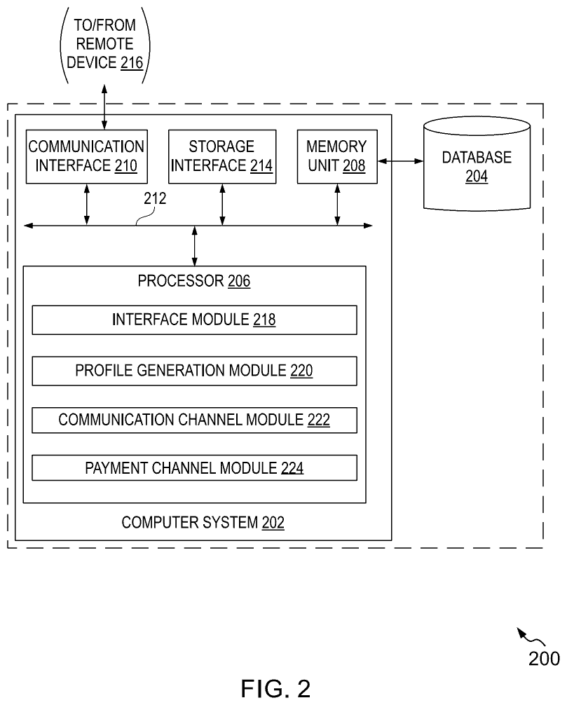

FIG. 2 illustrates a simplified block diagram of a server system 200, in accordance with an embodiment of the present disclosure. For example, the server system 200 is identical to the server system 102 as described in FIG. 1. In some embodiments, the server system 200 is embodied as a standalone physical server and/or has a cloud-based and/or SaaS-based (software as a service) architecture. The server system 200 is configured to provide access to the service exchange application 118 on the first device 116, the one or more second devices 108, 122, or 130, or the maturation service device 136.

The server system 200 includes a computer system 202 and a database 204. The computer system 202 includes at least one processor, such as a processor 206 for executing instructions, a memory unit 208, a communication interface 210, a communication bus 212, and a storage interface 214. The communication bus 212 enables entities of the computer system 202 to communicate with each other. The database 204 is an example of the database 124 of FIG. 1.

In some embodiments, the database 204 is integrated into the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute machine-readable instructions for performing one or more operations for rendering the user interface of the service exchange application 118. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like.

In an embodiment, the memory unit 208 is capable of storing machine-readable instructions. Examples of the memory unit 208 include a random-access memory (RAM), a read-only memory (ROM), a removable storage drive, a hard disk drive (HDD), and the like. It will be apparent to a person skilled in the art that the scope of the disclosure is not limited to realizing the memory unit 208 in the server system 200, as described herein. In another embodiment, the memory unit 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 216 such as the first device 116, one or more second devices 108, 122, or 130, and the maturation service device 136 connected to the network 110 (as shown in FIG. 1). In an implementation, the processor 206 is configured to install instances of the service exchange application 118 in the first device 116, the one or more second devices 108, 122, or 130, the maturation service device 136. This enables the implementation of a plurality of functionalities by multiple entities described in the disclosure.

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include an interface module 218, a profile generation module 220, a communication channel module 222, and a payment channel module 224. It should be noted that components, including the interface module 218, the profile generation module 220, the communication channel module 222, and the payment channel module 224, described herein, can be configured in a variety of ways, including electronic circuitries, digital arithmetic, and logic blocks, and memory systems in combination with software, firmware, and embedded technologies.

The interface module 218 is configured to generate several User Interfaces (UIs) in the first device 116, the one or more second devices 108, 122, or 130, the maturation service device 136, allowing the first stakeholder 112, the one or more second stakeholders 106, 120, or 128, or the maturation service 134 to access the software application 118 from their respective devices. For example, the interface module 218 is configured with specialized libraries or frameworks that provide pre-built components (widgets) like buttons, text boxes, windows, and menus. Furthermore, the interface module 218 may also be configured with layout managers used to organize the arrangement of widgets within a window. The layout managers handle how components resize and reposition when the window changes size.

Furthermore, interface module 218 is configured to receive an enrollment request for a candidate to participate in a service exchange application 118. The enrollment request is received from the one or more second stakeholders 106, 120, or 128 such as the candidate 120 themselves, the candidate institution 106, or the NGO 128. Furthermore, the interface module 218 is configured to render a candidate form on a display of a computing device, wherein the candidate form is configured to capture candidate information. The computing device may be selected from one or more second devices 108, 122, or 130.

The candidate information, in that regard, may include a full name, contact information (Phone number, email addresses, etc.), address, previous job titles and responsibilities, achievements and accomplishments, technical skills, soft skills, relevant certifications and licenses, educational backgrounds, references, assessment scores from assessments participated in. In regards to the candidate 120 being from dormant and untapped labor markets, the candidate information may further include criminal history, if any, medical history, disabilities that need to be accommodated, further essential requirements (such as housing, food coupons, conveyance allowance), psychological evaluations, letters of recommendation from previous employers, and the like.

In several embodiments, inputs from two or more of the one or more second stakeholders 106, 120, or 128 may be required. For example, the candidate 120 may provide basic candidate information such as name, contact details, and educational and professional qualification. In addition, the candidate institution 106 may provide certifications and licenses. Alternately or in addition, the NGO 128 may provide advocacy in the form of letters of recommendation and evaluations of social capital earned by the candidate 120.

The profile generation module 220 is configured to process the candidate information by performing mental health and personality assessments, personal attribute assessments, competency assessments, and knowledge assessments. The profile generation module 220 is further configured to generate a candidate talent profile (CTP) based on the processed candidate information. Furthermore, the profile generation module 220 is configured to store the CTP in the database 204.

While generating the candidate talent profile, the profile generation module 220 may (1) Consolidate the candidate information, (2) Extract key information, and (3) Structure the candidate talent profile. While consolidating the candidate information, the profile generation module 220 may collate resumes, cover letters, interview notes, assessment results, reference checks, and other relevant documents. The consolidated information may be organized as a digital document, a spreadsheet, or within an Applicant Tracking System (ATS). While extracting key information, the profile generation module 220 may identify relevant work experience, focusing on accomplishments and responsibilities that align with the job description, evaluate the scope and impact of their previous roles, extract both hard skills (technical skills) and soft skills (interpersonal skills), and identify evidence of the skills in their work history, education, and interview responses.

Education and qualification may be determined from relevant degrees, certifications, and training. Cultural fit may be determined from criminal histories, medical histories, psychological evaluations, records of community service, and the like. Furthermore, the profile generation module 220 may structure the candidate talent profile into several sections such as (1) Basic Information, (2) Summary/Overview, (3) Professional Experience, (4) Skills and Competencies, (4) Education and Qualifications, (5) Assessment Results, (6) Reference Checks, (7) Strengths and Weaknesses, and (8) Overall Evaluation.

The profile generation module 220 is further configured to generate a success talent profile. The success talent profile is indicative of the minimum competencies required to be eligible for participation in the employment side of the platform. The Success Talent Profile (STP) represents the core competencies required to be eligible for employment and includes personal attributes, competencies, knowledge, and experience. Some of the personal attributes measured include resilience, creativity, ambition, optimism, self-awareness, responsibility, readiness, self-motivation versatility. Examples of competency include detail-oriented, decision-making, leadership skills, time management, conflict resolution, teamwork, and organizational skills. The knowledge parameters are having a high school diploma or GED, English language proficiency, and basic computer skills.

The profile generation module 220 is further configured to compare the CTP and the STP to identify a deviation. In that regard, the profile generation module 220 may be configured to analyze the CTP to perform a gap analysis and identify potential gaps or deviations. The profile generation module 220 is then configured to confirm the presence of a potential gap or deviation. Where a majority of the potential gap or deviation is related to skills and knowledge, the profile generation module 220 may be configured to designate the candidate as eligible to participate in the service exchange application 118 for employment. Where a majority of the potential gap or deviation is related to core competencies, the profile generation module 220 may be configured to designate the candidate as eligible to receive services, including training. In several embodiments, the profile generation module 220 may further be configured to perform a matching operation to match the eligible candidate with business entities (for example, the business entity 112). In several embodiments, the profile generation module 220 may be configured to perform a service matching operation to match the eligible candidate with service providers (for example, the maturation service 134).

Furthermore, the profile generation module 220 may determine a potential gap or deviation between the success talent profile and the candidate talent profile. For determining the potential gap or deviation, the profile generation module 220 may perform one or more of (1) assess the candidate's demonstrated level of each required competency, (2) identify specific examples from their work history or interview responses that support their claims, (3) note any competencies where the candidate lacks sufficient evidence, (4) verify the candidate's proficiency in required technical skills, (5) consider any certifications, assessments, or portfolio items that demonstrate their abilities, (6) identify any skill gaps that would require additional training or development, (7) evaluate the relevance and depth of the candidate's work experience, (8) assess whether their experience aligns with the specific requirements of the job, (9) note any gaps in their work history or areas where they lack relevant experience, (10) verify the candidate's educational background and qualifications, (11) assess the candidate's alignment with the company's values and culture, (12) evaluate their communication style, teamwork abilities, and overall demeanor, and (13) any potential cultural mismatches.

In cases where the gaps or deviations related to core competencies are identified, the communication channel module 222 may facilitate maturation of the candidate 120 by enabling communication between the first device 116, the one or more second devices 108, 122, or 130, or the maturation service device 136. More specifically, the maturation service 134 may be able to communicate with the candidate 120, when enabled by the communication channel module 222, to provide training associated with digital literacy, communication skills, financial literacy, vocational skills training, time management and organization, physical therapy, psychiatric support, guidance for seeking seed investments, and the like. The communication enabled by the communication channel module 222 may be in the form of one or more of text messages, multimedia messages, audio calling, video calling, or contracts.

For example, through the communication channel module 222, the maturation service 134 may be able to conduct live webinars and workshops to provide interactive learning experiences and facilitate real-time Q&A. Engaging video tutorials and demonstrations may further be provided to illustrate complex concepts and skills. The communication channel module 222 may further enable the establishment of online communities and forums to foster peer-to-peer learning and support. The maturation service 134 may incorporate gamification elements, such as quizzes, badges, and leader boards, to enhance engagement and motivation. Further, the maturation service 134 may connect the candidate 120 with mentors who can provide guidance, support, and career advice. The maturation service 134 may offer virtual coaching sessions to provide personalized support and address individual learning needs. Also, the maturation service 134 may enable the candidate to create an online portfolio to demonstrate their skills.

In that regard, the communication channel module 222 may leverage real-time communication protocols for communications amongst the first device 116, the one or more second devices 108, 122, or 130, or the maturation service device 136. The real-time communication protocols are designed to establish persistent connections amongst the first device 116, the one or more second devices 108, 122, or 130, the maturation service device 136, and the server system 200, allowing for instant message delivery. Examples of real-time communication protocols include WebSockets, XMPP, etc. The server system 200 may act as a central hub for managing message delivery, ensuring reliability and security.

Furthermore, the communication channel module 222 may leverage message queues to temporarily store messages on the server system 200 before the messages are delivered. This ensures messages are not lost in case of temporary network issues or if the recipient is offline. Messages may further be stored in the database 204, allowing the first user 114, the one or more second users 104, 120, or 126, or the maturation service representative 132 to access their message history. Different storage mechanisms might be used for text messages and multimedia messages (e.g., separate databases or cloud storage for media files). In several embodiments, Content Delivery Networks (CDNs) may be used to efficiently deliver multimedia content (images, videos) to the first user 114, the one or more second users 104, 120, or 126, or the maturation service representative 132, reducing latency and improving performance.

Furthermore, CDNs store copies of media files on servers distributed around the world, allowing the first user 114, the one or more second users 104, 120, or 126, or the maturation service representative 132 to download them from the closest server. In addition, the communication channel module 222 may also enable audio and video calling. For audio calling, voice data is encoded and transmitted in real-time using protocols like WebRTC, SIP, or RTP. For video calling, video data, along with audio, is transmitted using similar protocols, often with added features for video encoding and decoding. The communication channel module 222 may also enable communication between the one or more second devices 108, 122, or 130 and the first device 116 associated with the business entity 112 (the first stakeholder 112).

Once the candidate 120 is hired for the job, they may go on to partially or entirely complete the job. The payment channel module 224 may be configured to enable the transfer of one or more financial instruments from the first device 116 to the one or more second devices 108, 122, or 130, in response to partial or entire completion of the job associated with the job opening. Furthermore, the payment channel module 224 may enable transfer of the financial assets through secure networks using security protocols such as Secure Service Layer (SSL)/Transport Layer Security (TLS), enabled by commercially available payment processors. The one or more financial instruments may include one or more of fiat currency, cryptocurrency, bonds, or stock options. In that regard, the payment channel module 224 may enable transfers though wire transfers, internet banking, payment gateways, trading platforms, cryptocurrency exchanges, and the like.

Although FIG. 2 shows the hardware elements of the server system 200, it is to be understood that other embodiments are not limited thereon. In other embodiments, the server system 200 may include fewer or a greater number of elements. Further, the labels or names of the elements are used only for illustrative purposes and do not limit the scope of the disclosure. One or more components can be combined to perform the same or substantially similar function.

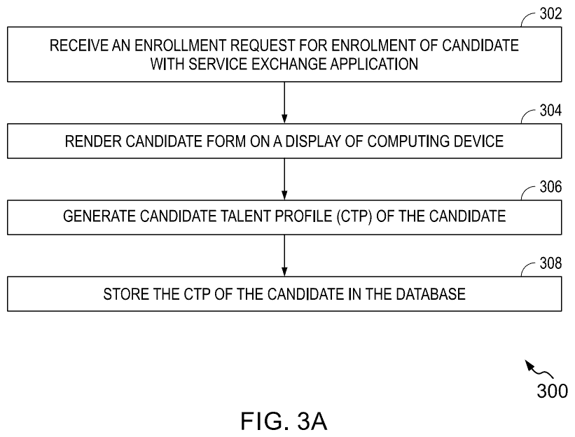

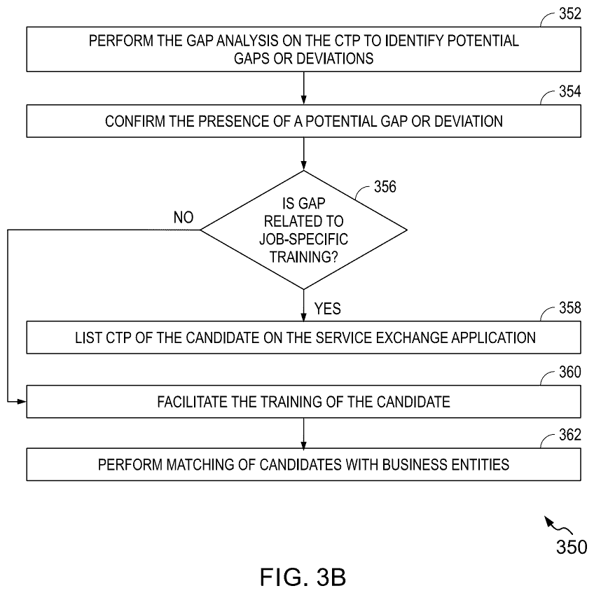

FIG. 3A illustrates a method 300 for generating the CTP of the candidate 120, in accordance with an embodiment of the present disclosure. The sequence of steps of the method 300 may not be necessarily executed in the same order as they are presented. Further, one or more steps may be grouped together and performed in the form of a single step, or one steps may have several sub-steps that may be performed in parallel or in a sequential manner.

At Step 302, the method 300 performed by the processor 206, includes receiving an enrolment request for enrolment of the candidate 120 with the service exchange application 118. In an embodiment, the service exchange application 118 receives the enrolment request from the candidate 120. In another embodiment, the service exchange application 118 receives the enrolment request from the candidate institution 106 or the NGO 128.

At Step 304, the method 300 includes rendering the candidate form on a display of a computing device. The computing device may be selected from the one or more second devices 108, 122, or 130. The candidate 120 is requested to fill and submit the candidate form to the service exchange application 118. In an embodiment, the candidate 120 may physically visit the screening center to receive the candidate form. The candidate 120 may then fill and submit the candidate form. In another embodiment, the candidate 120 may access the service exchange application 118 on the computing device to fill and submit the candidate form.

At Step 306, the method 300 includes generating, by the server system 200, a CTP of the candidate 120. In one embodiment, the processor 206 is configured to generate the CTP of the candidate 120 based at least on the processing of the candidate form. The server system 200 may generated the CTP by performing, mental health and personality assessments, personal attribute assessments, competency assessments, or knowledge assessments;

At Step 308, the method 300 includes storing the CTP of the candidate 120 in the database 204. The processor 206 is configured to run some automated database queries to store the CTP of the candidate 120 in the database 204.

The sequence of steps of the method 300 need not be necessarily executed in the same order as they are presented. Further, one or more steps may be grouped together and performed in form of a single step, or one step may have several sub-steps that may be performed in parallel or in sequential manner.:

FIG. 3B illustrates a method 350 for performing gap analysis on the CTP of the candidate 120, in accordance with an embodiment of the present disclosure. The sequence of steps of the process flow 350 may not be necessarily executed in the same order as they are presented. Further, one or more steps may be grouped together and performed in the form of a single step, or one step may have several sub-steps that may be performed in parallel or in a sequential manner.

At Step 352, the server system 200 is configured to perform the gap analysis on the CTP to identify potential gaps or deviations. In some examples, the server system 200 may utilize hardware-run algorithms to perform the gap analysis. The hardware-run algorithms may include artificial intelligence (AI) algorithms, machine learning (ML) algorithms, neural networks, deep learning (DL) algorithms, and the like. To perform the gap analysis, CTP of the candidate 120 may be compared with the STP pre-stored in the database 204. STP can be considered as the threshold profile to which the CTP is compared to.

At Step 354, the server system 200 confirms the presence of a potential gap or deviation.

At Step 356, the server system 200 identifies whether the gap is related to job-specific training.

In case the server system 200 identifies that the gap is related to job-specific training, at Step 358, the server system 200 is configured to list CTP of the candidate 120 on the service exchange application 118. In particular, business entities such as the business entity 112 can now view CTP of the candidate 120 on the service exchange application 118. Moreover, the business entities can now approach the candidate 120 to offer them employment opportunities.

In case the server system 200 identifies that the gap is not related to job-specific training (i.e., the gap may be related to mental health issues, etc.), at Step 360, the server system 200 is configured to facilitate the training of the candidate 120. In an example, the training may be performed to improve the mental health of the candidate 120. In another example, the training may be performed to increase education of the candidate 120.

At Step 362, the server system 200 is configured to perform the matching of the candidates 120 with the business entities. In an example, the server system 200 may recommend the candidate 120 to the business entity 112 based on their skillset. In another example, the server system 200 may recommend the various job openings to the candidate 120 based on the current job openings and/or the requirement of the business entity 112.

The sequence of steps of the process flow 350 need not be necessarily executed in the same order as they are presented. Further, one or more steps may be grouped together and performed in form of a single step, or one step may have several sub-steps that may be performed in parallel or in sequential manner.

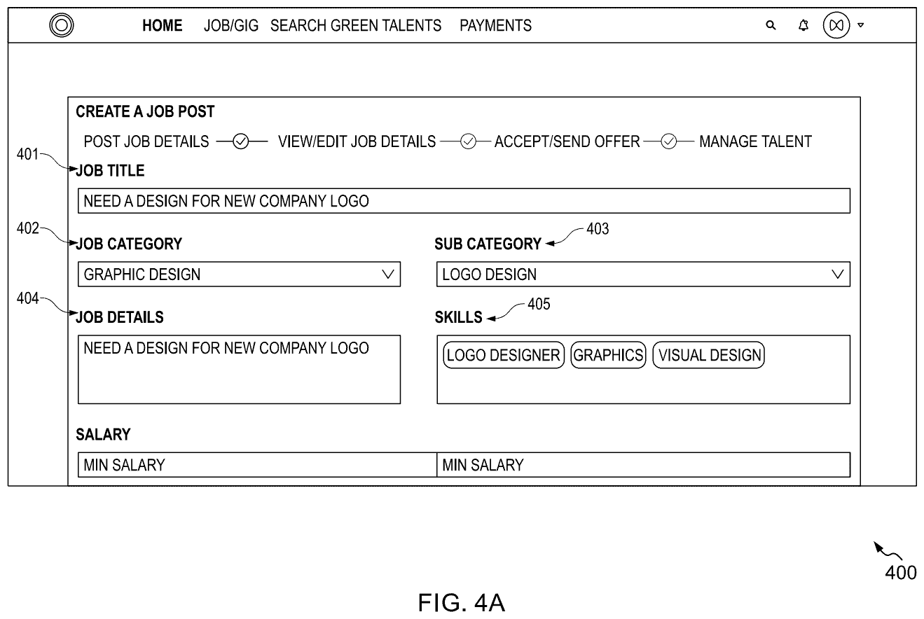

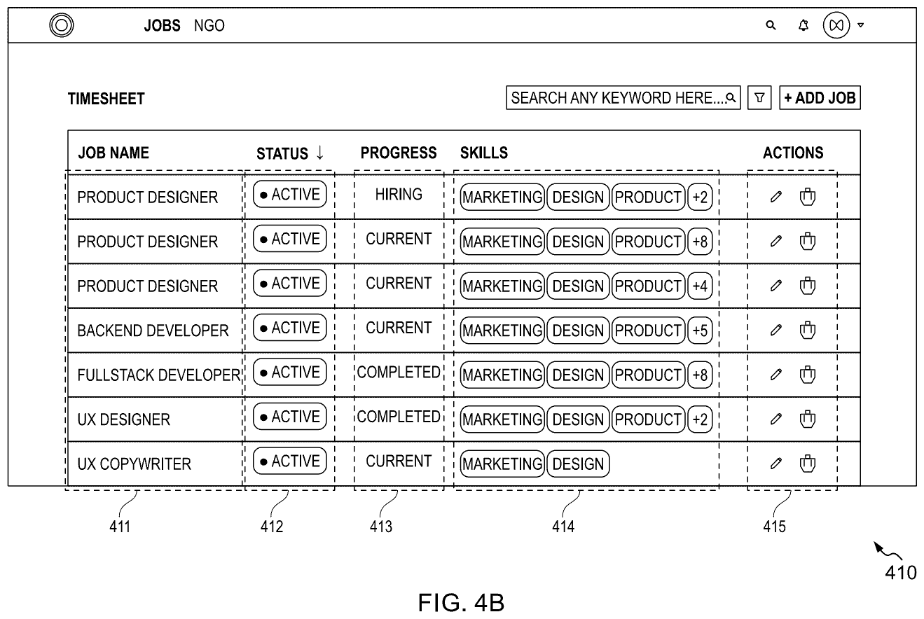

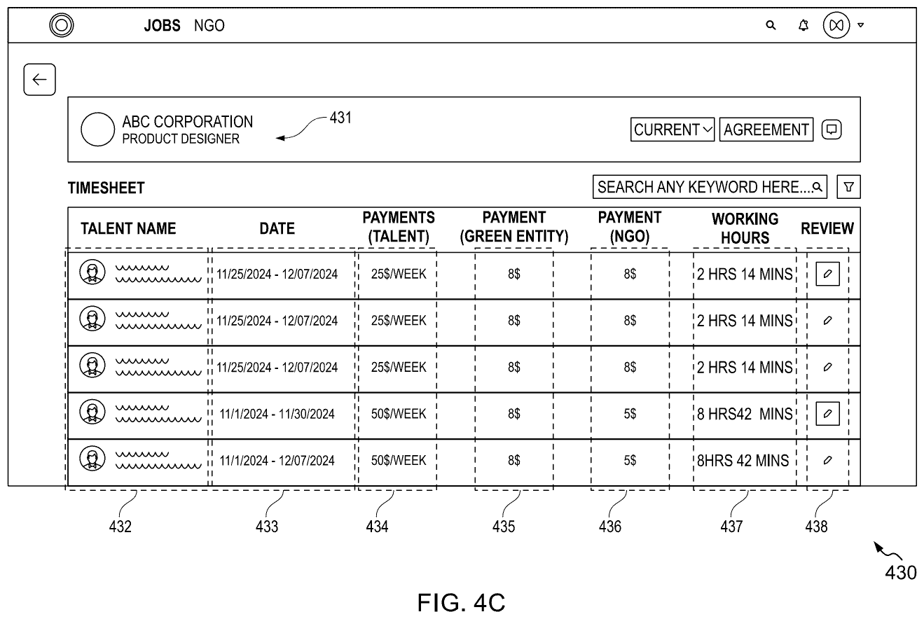

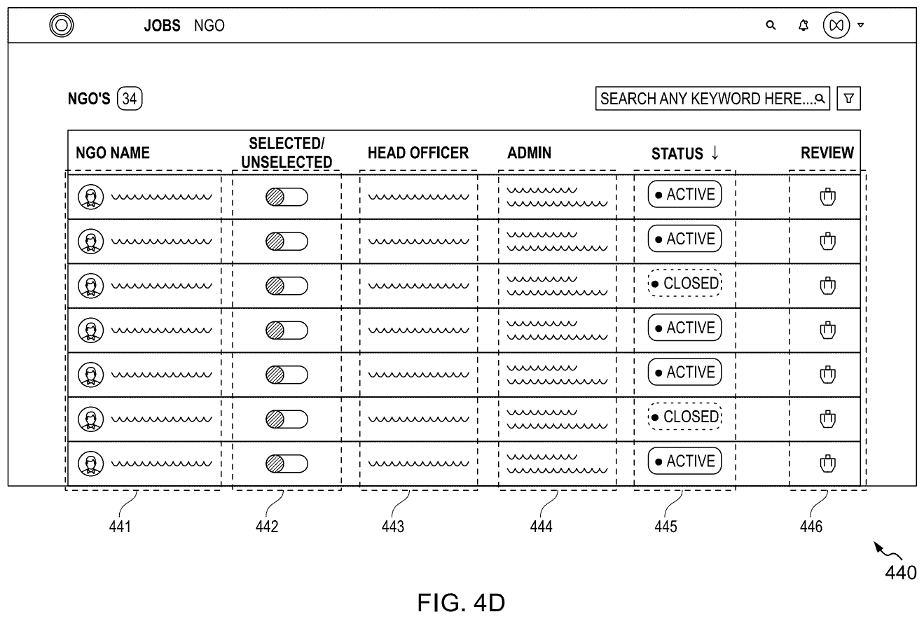

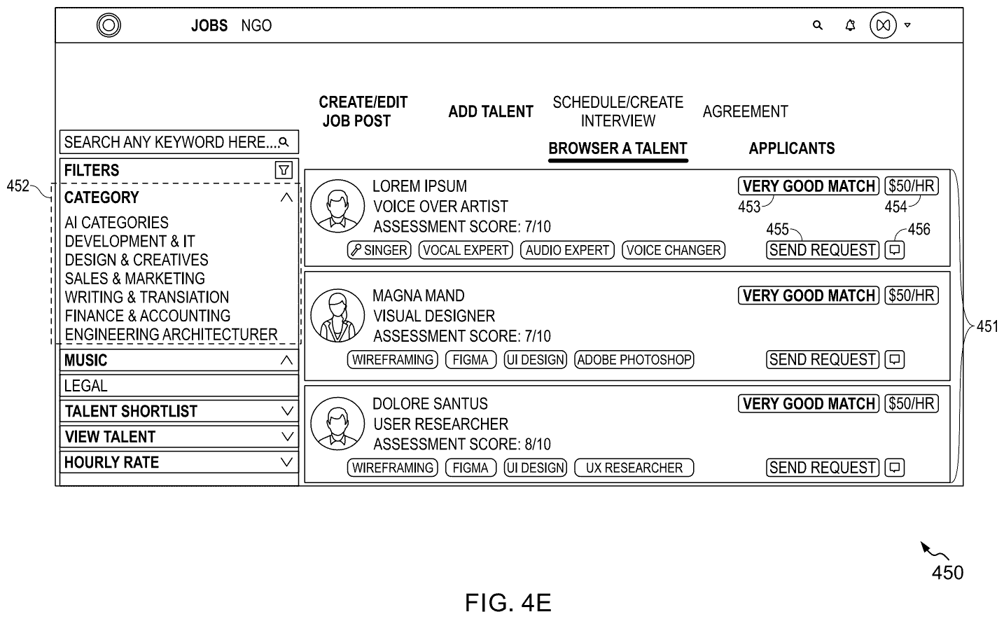

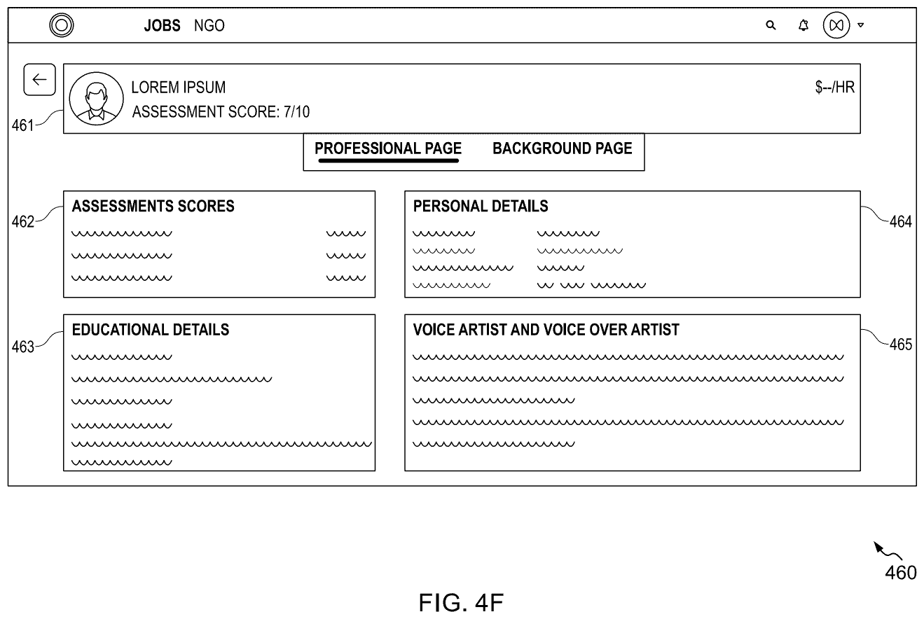

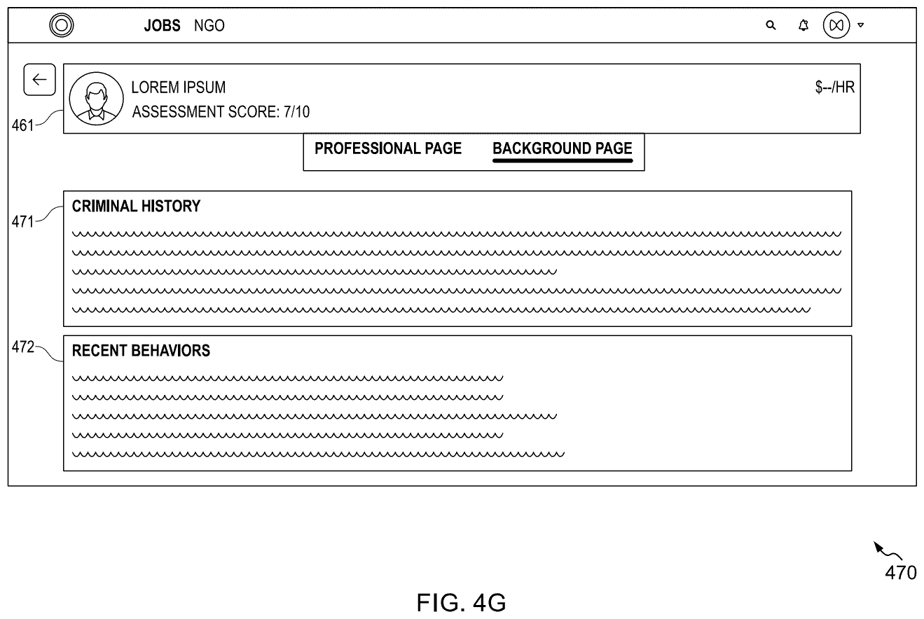

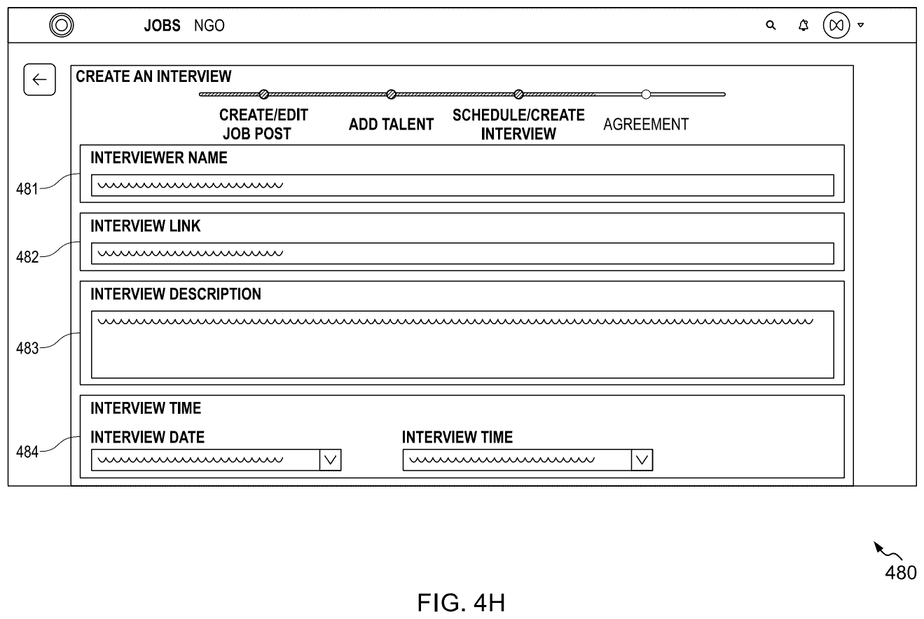

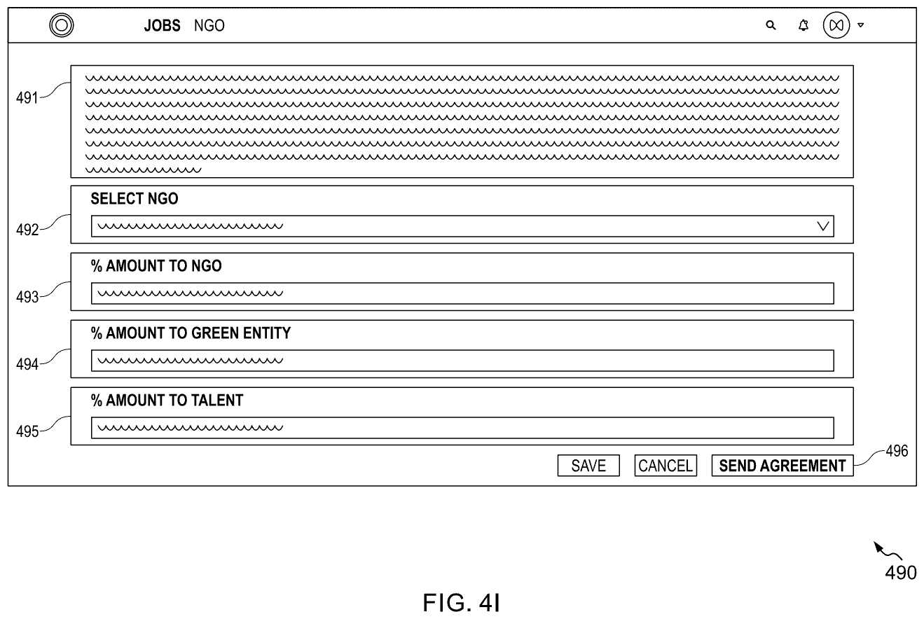

FIG. 4A illustrates a Graphic User Interface (GUI) 400 for the business entity 112, to be displayed on the first device 116, in accordance with an embodiment of the present disclosure. The GUI 400 depicts posting of a job by the business entity 112 with an associated job description. In that regard, the GUI depicts several interface elements (such as text boxes, buttons, toggles, links, etc. rendered on a display unit of the first device 116). Such as the first user 114, using the first device 116, can enter a job title 401. For example, the job title 401 may be “Need a design for new company logo”. Furthermore, the first user 114 can enter a job category 402 as “Graphic Design”, a sub-category 403 as “Logo Design”. In a “job details” 404 interface element, the first user 114 can enter the job description in all kinds of details such as whether it is a short term or a long-term job, a number of billable hours allotted to the job, a budget allocation per hour basis, a location of the job (such as remote, on-site, or hybrid), and the like. Furthermore, the first user 114 can enter skills required for the job in an interface element named skills 405. For example, the skill required may be “Logo Designer”, “Graphics”, and “Visual Design”.

FIG. 4B illustrates another GUI 410 for the business entity 112, generated by the service exchange application 118, in accordance with an embodiment of the present disclosure. The GUI 410 provides a list 411 of the jobs posted by the first user 114. For example, the titles of the jobs posted may be “Product Designer”, “Product Manager”, “Backend Developer”, “UX Designer” and the like. The GUI 410 further depicts status 412 of each job from the list 411. In that regard, the status may be “Active” or “Inactive”. Furthermore, the GUI 410 depicts progress indications 413 for all of the jobs from the list 411. The progress indications 413 may include “Hiring” when the business entity 112 is still screening candidates, “Current” when a candidate has been hired and is on the job, and “Completed” after the job has been completed by the hired candidate. The GUI 410 further depicts a listing of skills 414 for each job of the list 411. For example, skills required for “Product Designer” may be “Marketing”, “Design”, “Product Design”, etc. Furthermore, interface elements (such as buttons or toggles) under Actions 415 would allow the first user to either delete a job posting or the job description associated with the job posting.

FIG. 4C illustrates another GUI 420 for the business entity 112, generated by the service exchange application 118, in accordance with an embodiment of the present disclosure. The GUI 420 depicts an interface element with an identification 431 of the business entity 112. For example, the business entity 112 may be recognized by a name, a registration number and/or type of products offered. Furthermore, depicted in the GUI 420 is a list of candidates 432 who have been or had been employed by the business entity 112. A list of periods of employment 433 provides the periods for which each candidate is or was engaged with the business entity 112. A first list of disbursements 434 depicts payments made to each candidate of the list of candidates 432. A second list of disbursements 435 depicts payments made to a candidate institution associated with each candidate. A third list of disbursement 436 depicts payments made to an NGO associated with each candidate. A list of working hours 437 depicts total time spent by each candidate on the assigned tasks. A list of interface elements 438 depicts buttons that when toggled open up a text box allowing the first user 114 to enter performance feedback for each candidate. The performance feedback received from the business entity 112 may be added to the profile of the respective candidate for reference of future employers, maturation services, and candidate institutions.

FIG. 4D illustrates another GUI 440 for the business entity 112, generated by the service exchange application 118, in accordance with an embodiment of the present disclosure. The GUI 440 depicts a list of NGOs 441 available to the business entity 112. Furthermore, an array of toggles 442 would enable the first user 114 to select or unselect an NGO from the list of NGOs 441. A list of head officers 443 provides a name of a person in charge for each NGO, and a list of Admins 444 provides a name of a contact person for each NGO. A list of status 445 depicts whether an NGO is actively serving or has been shut down. An array of buttons 446 allows the first user 114 to delete an NGO from the list of NGOs 441.

FIG. 4E illustrates another GUI 450 for the business entity 112, generated by the service exchange application 118, in accordance with an embodiment of the present disclosure. The GUI 450 depicts a list of candidates 451 available to the business entity 112, represented by selected NGOs from the list of NGOs 441. Furthermore, several filters 452 may be applied to the list of candidates 451 to sort, enable, or disable the candidate from the GUI 450. The filters 452 may include, for example, “Development & IT”, “Design & Creatives”, “Sales & Marketing”, and the like. Furthermore, a rating 453 has been provided to each candidate from the list of candidates 451. The rating 453 may be a qualitative rating, such as “very good match”, “does not match”, etc. or a quantitative rating, such as “9/10” or “4.1/5”, etc. A billing rate 454, for example $50/hour” provides cost of hiring the candidate. An interface element 455 allows the first user 114 to send a request to the candidate inviting them to apply for the job. Another interface element 456 allows the first user 114 to directly send a custom message to the candidate through the software application 118 and receive a response in return.

FIG. 4F illustrates another GUI 460 for the business entity 112, generated by the service exchange application 118, in accordance with an embodiment of the present disclosure. The GUI 460 depicts an interface element 461 illustrating a photograph of a candidate, their name, and an overall assessment score. Another interface element 462 provides additional assessment scores, such as “Skill Score”, “Health Score”, “Overall Score”, etc. A third interface element 463 illustrates educational qualification of the candidate, such as name of the college degree, name of the college, name of the school, and the like. A fourth interface element 464 illustrates personal information such as full name, e-mail address, residential address, contact number, etc. A fifth interface element 465 depicts professional qualifications including a title, such as “Vocal Artist and Voice Over Artist”, followed by detailed account of skills and accomplishments.

FIG. 4G illustrates another GUI 470 for the business entity 112, generated by the service exchange application 118, in accordance with an embodiment of the present disclosure. The GUI 470 depicts the interface element 461 as described before. In addition, the GUI 470 depicts another interface element 471 providing criminal history of the candidate, and a third interface element 472 enlisting recent observed behaviors of the candidate. In that regard, the recent observed behaviors may be provided by previous employers, candidate institutions, NGOs, and maturation services. The GUI 470 may also be modified to depict additional information such as verification of professional background, verification of educational background, credit history, psychological evaluations, and like. In other words, the GUI 470 provides pre-employment screening information of the candidate, to the business entity 112.

FIG. 4H illustrates another GUI 480 for the business entity 112, generated by the service exchange application 118, in accordance with an embodiment of the present disclosure. The GUI 480 enables the first user 114 to schedule an interview with a candidate. The interview may be scheduled before or after pre-employment screening of the candidate. The GUI 480 includes several interface elements in the form of text fields. A first text field 481 allows entry of a name of an interviewer. A second text field 482 allows a link for a video/audio meeting. In alternate scenarios, the second text field 482 may allow entry of a physical location for in-person interview. A third text field 483 allows the first user 114 to provide a brief or a detailed description and/or agenda of the interview. Furthermore, a fourth set of text fields 484 allows the first user 114 to enter a date, and a starting and/or an ending time of the interview. Once the interview is created, the information entered may be sent to the respective candidate, an associated candidate institution, or an associated NGO.

FIG. 4I illustrates another GUI 490 for the business entity 112, generated by the service exchange application 118, in accordance with an embodiment of the present disclosure. The GUI 490 enables the first user 114 to generate and share an employment contract with a candidate, an associated candidate institution, and an associated NGO. The GUI 490 includes a first interface element 491 with terms and conditions of the employment contract. A second interface element 492 enables the first user 114 to select an intermediary NGO. A third interface element 493 enables the first user 114 to assign a share of a payable amount to the selected NGO. A fourth interface element 494 enables the first user 114 to assign a share of the payable amount to the associated candidate institution. A fifth interface element 495 enables the first user 114 to assign a share of the payable amount to the candidate. Also, a sixth interface element 496 designed in the form of a button allows the first user 114 to send the generated employment contract to one or more of the candidate, the associated candidate institution, or the associated NGO.

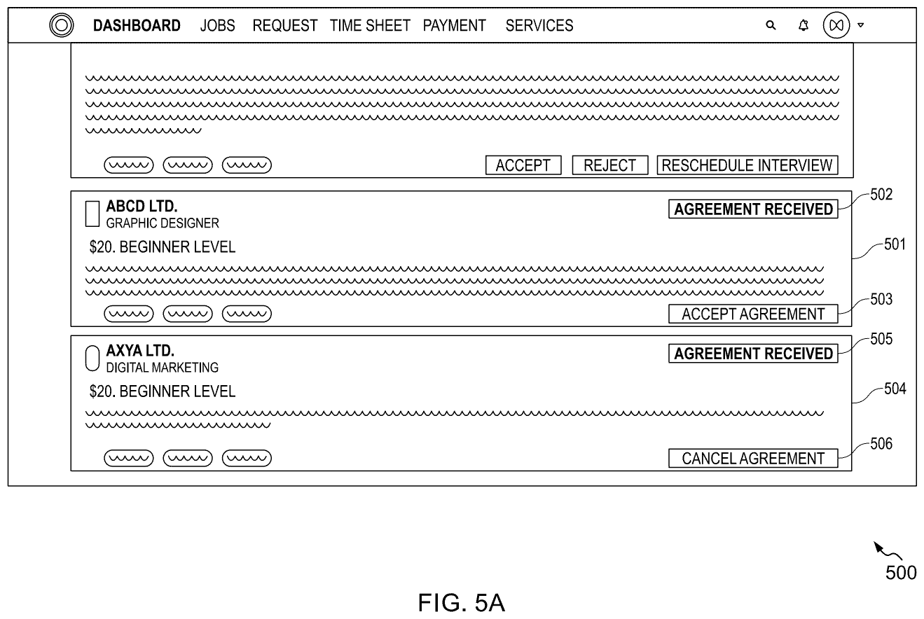

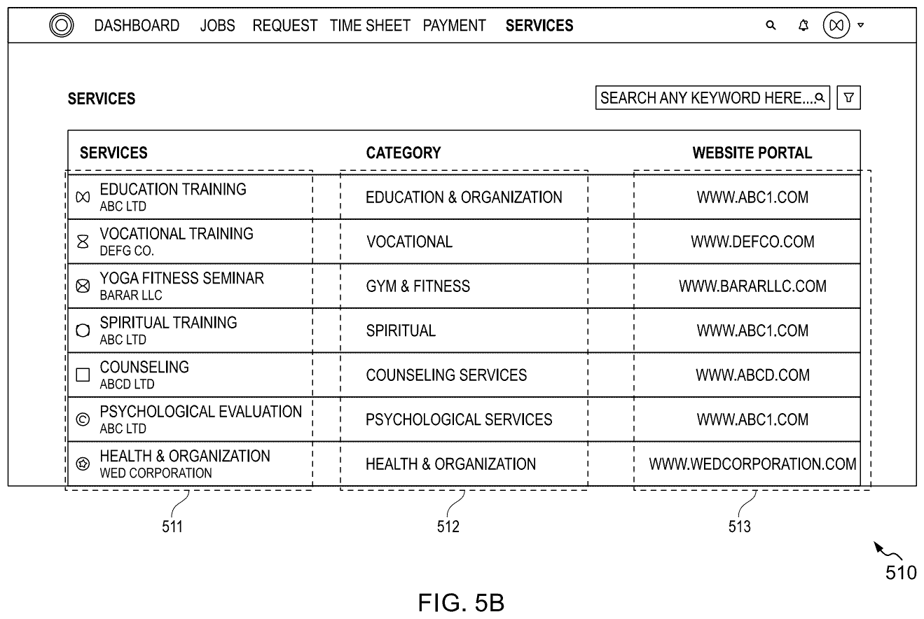

FIG. 5A illustrates a GUI 500 for the candidate 120, generated by the service exchange application 118, in accordance with an embodiment of the present disclosure. The GUI 500 depicts listing of two business entities interested in the candidate. An interface element 501 illustrates a brief overview of a first business entity, and another interface element 504 illustrates a brief overview of a second business entity. Furthermore, an interface element 502 depicts that an employment contract has been received from the first business entity, another interface element 505 depicts that an employment contract received from the second business entity has been accepted. Also, an interface element 503 provides a toggle for the candidate 120 to enable them to accept the employment contract from the first business entity, and another interface element 506 provides a toggle for the candidate 120 to enable them to cancel the previously accepted employment contract from the second business entity.

FIG. 5B illustrates another GUI 510 for the candidate 120, generated by the service exchange application 118, in accordance with an embodiment of the present disclosure. The GUI 510 depicts a list of maturation services 511 available to the candidate 120 to enable the candidate 120 to eliminate the potential gap or deviation. It is to be noted that in several scenarios, the business entities offering employment may also double as maturation services providing several kinds soft skills and hard skill training. A list of categories 512 provides a service category for each one of the maturation services in the list 511. The service categories, for example, may include “Education & Organization”, “Vocational Training”, “Gym & Fitness”, “Spiritual Training”, “Counseling Services”, “Psychological Services”, “Health & Organization”, and the like. A list of Uniform Resource Locators (URLs) 513 provides an online network address for each one of the list of maturation services 511.

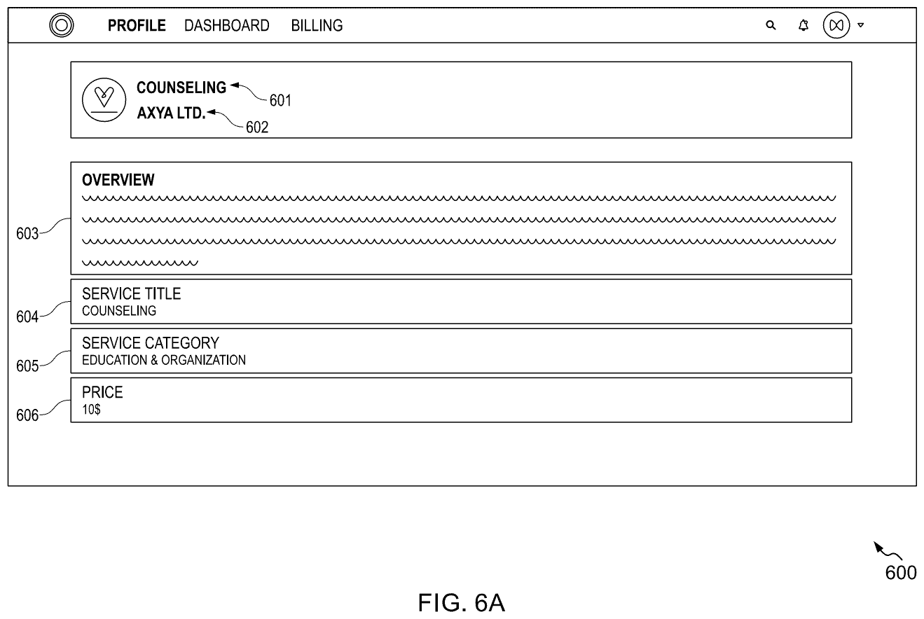

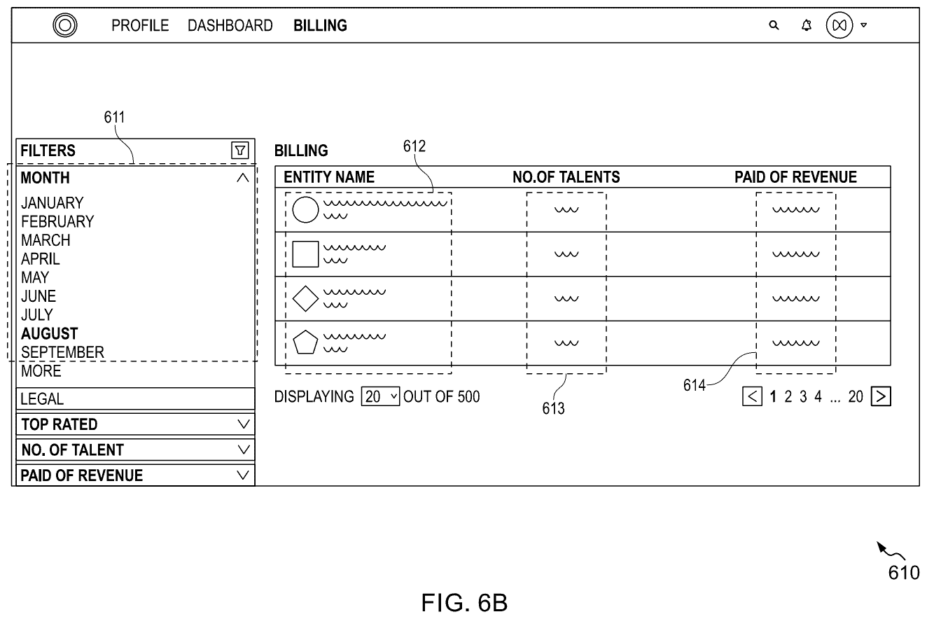

FIG. 6A illustrates a GUI 600 for the maturation service 134, generated by the service exchange application 118, in accordance with an embodiment of the present disclosure. The GUI 600 depicts profile page of the maturation service 134. In that regard, the GUI 600 includes a category 601 (for example, “Counseling”) of the maturation service 134, a registered name 602 of the maturation service 134, an overview 603 providing summary of the services, mission statement, core values, etc., a service title 604, a service category or a sub-category 605, and a price 606 (for example, price per session per individual).

FIG. 6B illustrates another GUI 610 for the maturation service 134, generated by the service exchange application 118, in accordance with an embodiment of the present disclosure. The GUI 610 depicts a billing page for the maturation service 134 enlisting candidate institutions associated with the maturation service 134. The billing period may be filtered based on a monthly filter provided by an interface element 611. Furthermore, for every selected period a list of candidate institutions 612 may be generated. The candidate institutions may be correctional facilities (e.g., prisons, jails, detention centers, etc.), healthcare institutions (e.g., hospitals, clinics, etc.), assisted living facilities and nursing facilities, homeless shelter facilities, etc. A list of candidate counts 613 provides a count of candidates for each candidate institution, who have been provided training and education by the maturation services 134. A list of revenues 614 lists individual revenue generated by the maturation service 134 through each one of the list of candidate institutions 612.

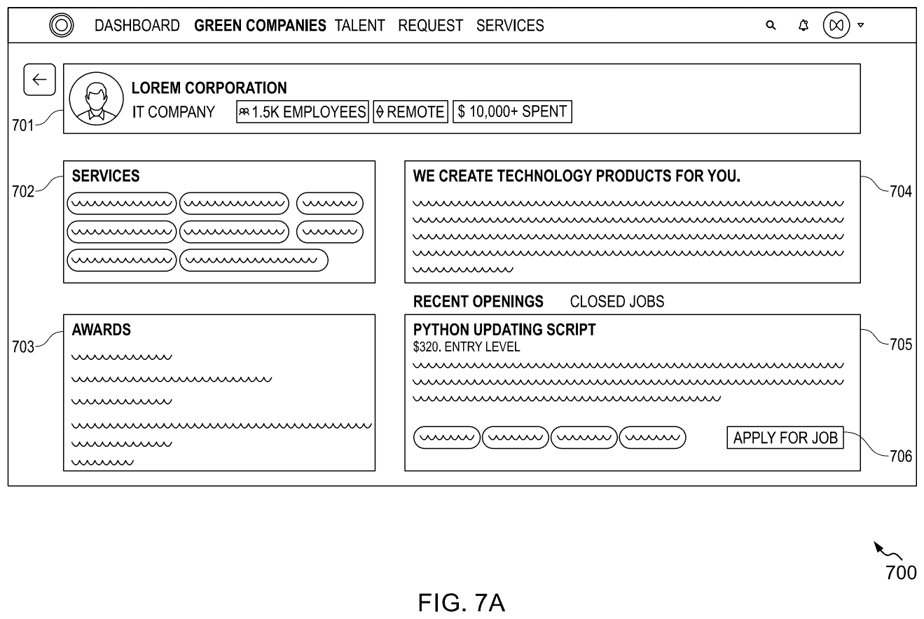

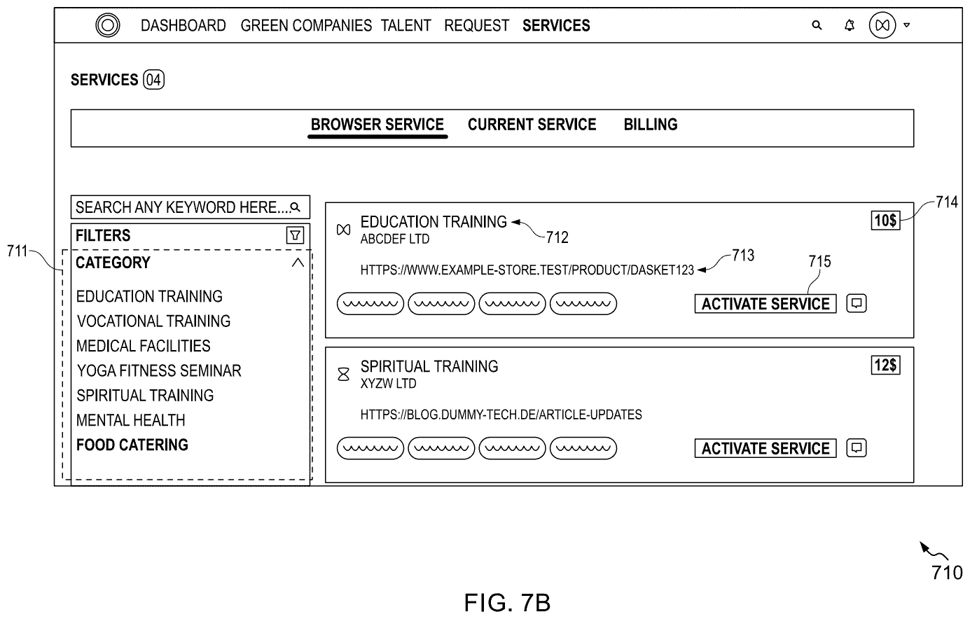

FIG. 7A illustrates a GUI 700 for the candidate institution 106, generated by the service exchange application 118, in accordance with an embodiment of the present disclosure. The GUI 700 is a profile page of a business entity, generated for viewing by the candidate institution 106. The GUI 700 includes a name and title of the business entity in an interface element 701. Furthermore, an interface element 702 lists services provided by the business entity. An interface element 703 illustrates awards and recognition won by the business entity. Another interface element 704 depicts mission and vision statement of the business entity. A fifth interface element 705 provides a synopsis of a job opening posted by the business entity. The candidate institution 106 may apply on behalf of a candidate by clicking on “Apply for Job” button 706.

FIG. 7B illustrates another GUI 710 for the candidate institution 106, generated by the service exchange application 118, in accordance with an embodiment of the present disclosure. The GUI 710 depicts a list of maturation services available to the candidate institution 106. An interface element 711 allows the maturation services to be filtered based service categories, such as “Education Training”, “Vocational Training”, “Medical Facilities”, “Spiritual Training”, etc. In the generated list, there is provided a name and a title 712 of a maturation service, a URL 713 for accessing the maturation service, a pricing value 714 (for example, per session per candidate) for the maturation service, and an activation button 715 for activating the maturation service. Once activated, the candidate institution 106 may be able to exchange text and multimedia messages and attend audio and video calls with the maturation service.

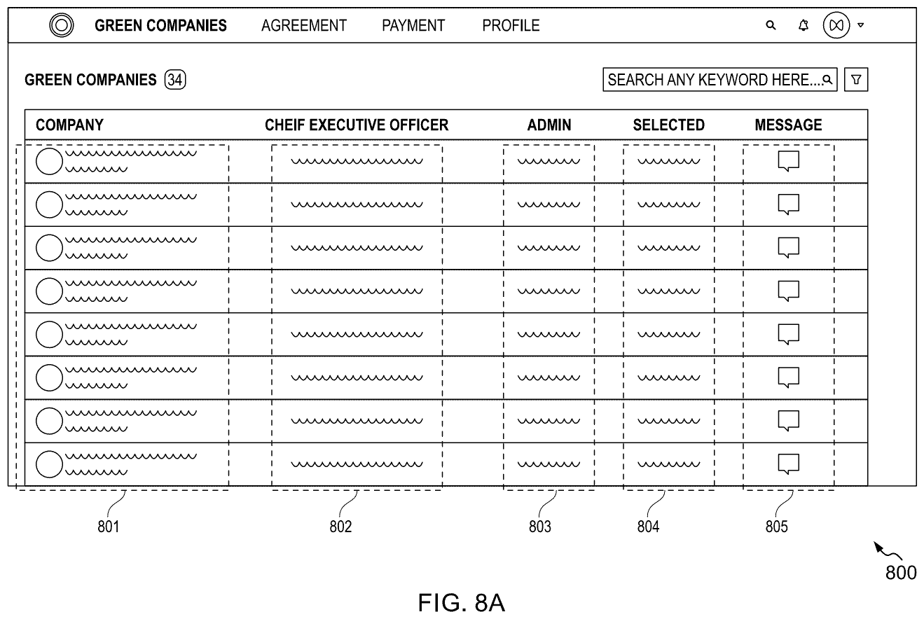

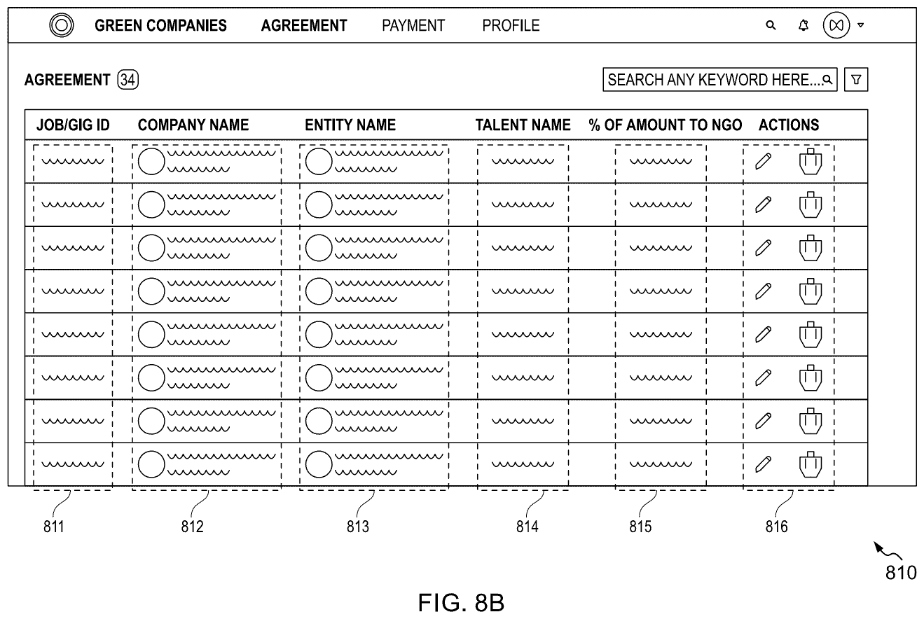

FIG. 8A illustrates a GUI 800 for the NGO 128, generated by the service exchange application 118, in accordance with an embodiment of the present disclosure. The GUI 800 depicts a list of business entities 801 available to the NGO 128. Furthermore, a list of Chief Operating Officers (CEOs) 802 provide names of chief executives of each business entity of the list of business entities 801. A list of administrators 803 provides names and email addresses of contact persons from each one of the list of business entities 801. A list of status 804 provides information as if a business entity has opted to engage with the NGO 128. If the status depicts “Yes”, it indicates that the corresponding business entity is interested in engaging with the NGO 128. Alternately, if the status depicts “No”, it indicates that the corresponding business entity is not inclined towards engaging with the NGO 128. Furthermore, an array of message buttons 805 allows the NGO representative 126 to contact the business entity and build rapport with them for future transactions.

FIG. 8B illustrates another GUI 810 for the NGO 128, generated by the service exchange application 118, in accordance with an embodiment of the present disclosure. The GUI 810 depicts employment contracts that have been mediated by the NGO 128 with several business entities, candidate institutions, and candidates. In that regard, the GUI 810 depicts a list of identifications 811 that provides a unique identification for each employment contract. A list of business entities 812 provides a business entity associated with each employment contract. A list of candidate institutions 813 provides a candidate institution associated with each employment contract. Also, a list of candidates 814 provides a candidate associated with each employment contract. Furthermore, a list of stakes 815 provides a percentage of revenue to which the NGO 128 is entitled through each employment contract. An array of buttons 816 as interface elements allows the NGO representative 126 to either edit the information respective to each employment contract or entirely delete an employment contract.

It is to be noted that FIGS. 4A-8B only provide some of the GUIs that are available through the service exchange application 118. There are several other forms of representation of data pertinent to the business entity 112, the candidate institution 106, the candidate 120, and the NGO 128 that have not been provided for the sake of brevity. Furthermore, different alternative terms may be used for the business entity 112, the candidate institution 106, the candidate 120, and the NGO 128, depending upon a jurisdiction in which the service exchange application 118 may be marketed. For example, “business entity” may also be referred to as “green company”, “candidate institution” may also be referred to as “green entity” or just “entity”, and “maturation service” may also be referred to as “green service”.

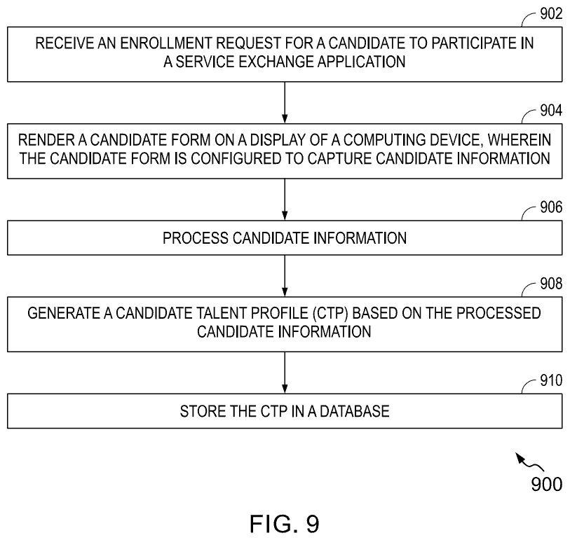

FIG. 9 illustrates a method 900 for service exchange in dormant and untapped labor markets, in accordance with an embodiment of the present disclosure. The method 900 depicted in the flow diagram may be executed by, for example, at least one server system 200. Steps of the flow diagram of the method 900, and combinations of steps in the flow diagram of the method 900, may be implemented by, for example, hardware, firmware, a processor, circuitry, and/or a different device associated with the execution of software that includes one or more computer program instructions. The method 900 starts at Step 902.

At Step 902, the server system 200 receives an enrollment request for a candidate to participate in the service exchange application 118. The enrollment request may be received from the one or more second devices 108, 122, or 130. At Step 904, the server system 200 renders a candidate form on a display of a computing device (for example, the one or more second devices 108, 122, or 130), wherein the candidate form is configured to capture candidate information. At Step 906, the server system 200 processes the candidate information. The processing of the candidate information includes performing mental health and personality assessments, personal attribute assessments, competency assessments, or knowledge assessments. At Step 908, the server system 200 generates a candidate talent profile (CTP) based on the processed candidate information. At Step 910, the server system 200 stored the CTP in the database 204.

Furthermore, in one embodiment, the server system 200 compares the CTP with a pre-defined Success Talent Profile (STP) to identify a deviation. Furthermore, the server system 200 analyzes the CTP to perform a gap analysis and identify potential gaps or deviations. Furthermore, the server system 200 confirms the presence of a potential gap or deviation. In one embodiment, the server system 200 determines that a majority of the potential gap or deviation is related to skills and knowledge, and therefore, the sever system 200 designates the candidate as eligible to participate in the service exchange application 118 for employment. In another embodiment, the server system 200 determines that a majority of the potential gap or deviation is related to core competencies, and therefore, the server system 200 designates the candidate as eligible to receive services, including training, for example, from the maturation service 134. Furthermore, in several embodiments, the server system 200 may perform a matching operation to match the eligible candidate with business entities. Additionally, in several embodiments, the server system 200 may perform a service matching operation to match the eligible candidate with service providers.

In several embodiments, the one or more financial instruments are distributed, by the server system 200, amongst the one or more second stakeholders 106, 120, or 128 in conformance with terms and conditions enlisted in an employment contract transmitted to the one or more second devices 108, 122, or 130. In several embodiments, the one or more financial instruments include one or more of fiat currency, cryptocurrency, bonds, or stock options. Furthermore, in several embodiments, the server system 200 receives performance feedback concerning the partial or the entire completion of the job associated with the job opening, by the candidate 120. Furthermore, the server system 200 adds performance feedback to the candidate information.

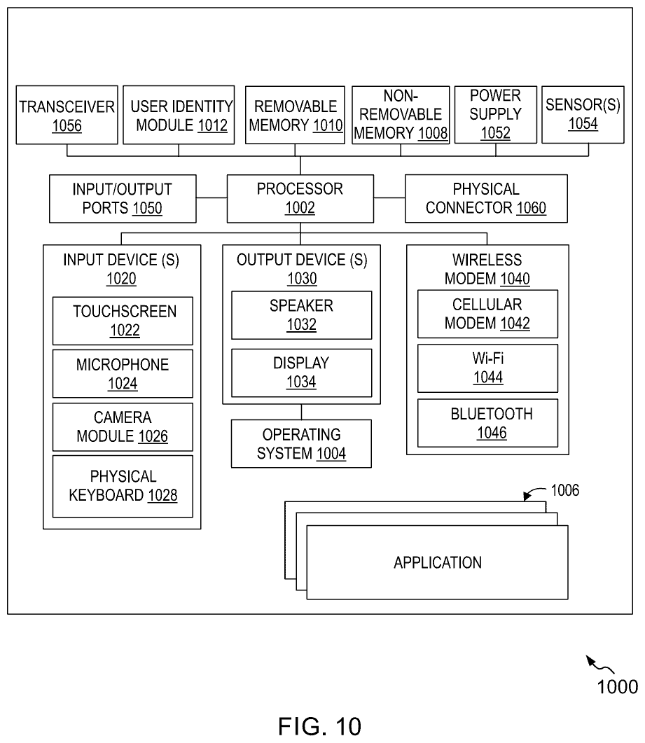

FIG. 10 shows a simplified block diagram of a computing device 1000 (for example the server system 102, 200, the first device 116, the one or more second devices 108, 122, or 130, the maturation service device 136, etc.) capable of implementing the various embodiments of the present disclosure. The computing device 1000 is depicted to include one or more applications such as the service exchange application 118 facilitated by the server system 102. The service exchange application 118 can be an instance of an application downloaded from the server system 102 or a third-party server. The service exchange application 118 is capable of communicating with the server system 102 for providing service exchange between the business entities 112 and the one or more second stakeholders 106, 120, or 128.

It should be understood that the computing device 1000 as illustrated and hereinafter described is merely illustrative of one type of device and should not be taken to limit the scope of the embodiments. As such, it should be appreciated that at least some of the components described below in connection with the computing device 1000 may be optional and thus in an example embodiment may include more, less, or different components than those described in connection with the embodiment of FIG. 10. As such, among other examples, the computing device 1000 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated computing device 1000 includes a controller or a processor 1002 (e.g., a signal processor, microprocessor, ASIC, or other control and processing logic circuitry) for performing such tasks as signal coding, data processing, image processing, input/output processing, power control, and/or other functions. An operating system 1004 controls the allocation and usage of the components of the computing device 1000 and supports one or more application programs such as the service exchange application 1006 (same as the service exchange application 118), that implements one or more of the innovative features described herein. In addition to the service exchange application 1006, the applications may include common mobile computing applications (e.g., telephony applications, email applications, calendars, contact managers, web browsers, messaging applications) or any other computing application.

The illustrated computing device 1000 includes one or more memory components, for example, a non-removable memory 1008 and/or removable memory 1010. The non-removable memory 1008 and/or the removable memory 1010 may be collectively known as a database in an embodiment. The non-removable memory 1008 can include RAM, ROM, flash memory, a hard disk, or other well-known memory storage technologies. The removable memory 1010 can include flash memory, smart cards, or a Subscriber Identity Module (SIM). The one or more memory components can be used for storing data and/or code for running the operating system 1004 and the service exchange application 1006. The computing device 1000 may further include a user identity module (UIM) 1012. The UIM 1012 may be a memory device having a processor built in.

The UIM 1012 may include, for example, a subscriber identity module (SIM), a universal integrated circuit card (UICC), a universal subscriber identity module (USIM), a removable user identity module (R-UIM), or any other smart card. The UIM 1012 typically stores information elements related to a mobile subscriber. The UIM 1012 in the form of the SIM card is well known in Global Systems for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The computing device 1000 can support one or more input devices 1020 and one or more output devices 1030. Examples of the input devices 1020 may include, but are not limited to, a touch screen/a display screen 1022 (e.g., capable of capturing finger tap inputs, finger gesture inputs, multi-finger tap inputs, multi-finger gesture inputs, or keystroke inputs from a virtual keyboard or keypad), a microphone 1024 (e.g., capable of capturing voice input), a camera module 1026 (e.g., capable of capturing still picture images and/or video images) and a physical keyboard 1028. Examples of the output devices 1030 may include, but are not limited to, a speaker 1032 and a display 1034. Other possible output devices can include piezoelectric or other haptic output devices. Some devices can serve more than one input/output function. For example, the touch screen 1022 and the display 1034 can be combined into a single input/output device.

A wireless modem 1040 can be coupled to one or more antennas (not shown in FIG. 10) and can support two-way communications between the processor 1002 and external devices, as is well understood in the art. The wireless modem 1040 is shown generically and can include, for example, a cellular modem 1042 for communicating at long range with the mobile communication network, a Wi-Fi compatible modem 1044 for communicating at short range with an external Bluetooth-equipped device, or a local wireless data network or router, and/or a Bluetooth-compatible modem 1046. The wireless modem 1040 is typically configured for communication with one or more cellular networks, such as a GSM network for data and voice communications within a single cellular network, between cellular networks, or between the computing device 1000 and a public switched telephone network (PSTN).

The computing device 1000 can further include one or more input/output ports 1050, a power supply 1052, one or more sensors 1054 for example, an accelerometer, a gyroscope, a compass, or an infrared proximity sensor for detecting the orientation or motion of the computing device 1000 and biometric sensors for scanning biometric identity of an authorized user, a transceiver 1056 (for wirelessly transmitting analog or digital signals) and/or a physical connector 1060, which can be a USB port, IEEE 794 (Fire Wire) port, and/or RS-232 port. The illustrated components are not required or all-inclusive, as any of the components shown can be deleted and other components can be added.

The disclosed method with reference to FIG. 9, or one or more operations of the method 900 may be implemented using software including machine-readable instructions stored on one or more machine-readable media (e.g., non-transitory machine-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during the implementation of the disclosed methods or systems may also be stored on one or more machine-readable media (e.g., non-transitory machine-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 102 and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a machine-readable medium, wherein the computer programs are configured to cause a processor or the computer to perform one or more operations. A machine-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory machine-readable media.

Non-transitory machine-readable media include any type of tangible storage media. Examples of non-transitory machine-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory machine-readable media. Examples of transitory machine-readable media include electric signals, optical signals, and electromagnetic waves. Transitory machine-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for service exchange in dormant and untapped labor markets, comprises:
receiving, by a server system, an enrollment request for a candidate to participate in a service exchange application;
rendering, by the server system, a candidate form on a display of a computing device, wherein the candidate form is configured to capture candidate information;
processing, by the server system, the candidate information, comprising performing:
mental health and personality assessments,
personal attribute assessments,
competency assessments, or
knowledge assessments;
generating, by the server system, a candidate talent profile (CTP) based on the processed candidate information; and
storing, by the server system, the CTP in a database.

2. The method as claimed in claim 1, further comprising comparing, by the server system, the CTP with a pre-defined success talent profile (STP) to identify a deviation.

3. The method as claimed in claim 2, further comprising analyzing, by the server system, the CTP to perform a gap analysis and identify potential gaps or deviations.

4. The method as claimed in claim 3, further comprising confirming, by the server system, the presence of a potential gap or deviation.

5. The method as claimed in claim 4, further comprising:
determining, by the server system, that a majority of the potential gap or deviation is related to skills and knowledge; and
designating, by the server system, the candidate as eligible to participate in the service exchange application for employment.

6. The method as claimed in claim 4, further comprising:
determining, by the server system, that a majority of the potential gap or deviation is related to core competencies; and
designating, by the server system, the candidate as eligible to receive services, the service comprising training.

7. The method as claimed in claim 5, further comprising performing, by the server system, a matching operation to match the eligible candidate with business entities.

8. The method as claimed in claim 6, further comprising performing, by the server system, a service matching operation to match the eligible candidate with service providers.

9. A server system for service exchange in dormant and untapped labor markets, comprises:
a memory unit comprising machine-readable instructions; and
a processor operably connected to the memory unit, the processor configured to execute the machine-readable instructions, that when executed by the processor, cause the server system to:
receive an enrollment request for a candidate to participate in a service exchange application;
render a candidate form on a display of a computing device, wherein the candidate form is configured to capture candidate information;
process the candidate information, comprising performing:
mental health and personality assessments,
personal attribute assessments,
competency assessments, or
knowledge assessments;
generate a candidate talent profile (CTP) based on the processed candidate information; and
store the CTP in a database.

10. The server system as claimed in claim 9, wherein the server system is further caused to compare the CTP with a pre-defined success talent profile (STP) to identify a deviation.

11. The server system as claimed in claim 10, wherein the server system is further caused to analyze the CTP to perform a gap analysis and identify potential gaps or deviations.

12. The server system as claimed in claim 11, wherein the server system is further caused to confirm the presence of a potential gap or deviation.

13. The server system as claimed in claim 12, wherein the server system is further caused to:
determine that a majority of the potential gap or deviation is related to skills and knowledge; and
designate the candidate as eligible to participate in an employment platform.

14. The server system as claimed in claim 12, wherein the server system is further caused to:
determine that a majority of the potential gap or deviation is related to core competencies; and
designate the candidate as eligible to receive services, including training.

15. The server system as claimed in claim 13, wherein the server system is further caused to perform a matching operation to match the eligible candidate with business entities.

16. The server system as claimed in claim 14, wherein the server system is further caused to perform a service matching operation to match the eligible candidate with service providers.

17. A non-transitory computer-readable storage medium comprising machine-readable instructions that, when executed by a processor of a server system, cause the server system to perform a method comprising:
receiving an enrollment request for a candidate to participate in a service exchange application;
rendering a candidate form on a display of a computing device, wherein the candidate form is configured to capture candidate information;
processing the candidate information, comprising performing:
mental health and personality assessments,
personal attribute assessments,
competency assessments, or
knowledge assessments;
generating a candidate talent profile (CTP) based on the processed candidate information; and
storing the CTP in a database.

18. The non-transitory computer-readable storage medium as claimed in claim 17, wherein the machine-readable instructions further cause the server system to compare the CTP with a pre-defined success talent profile (STP) to identify a deviation.

19. The non-transitory computer-readable storage medium as claimed in claim 18, wherein the machine-readable instructions further cause the server system to analyze the CTP to perform a gap analysis and identify potential gaps or deviations.

20. The non-transitory computer-readable storage medium as claimed in claim 18, wherein the machine-readable instructions further cause the server system to confirm the presence of a potential gap or deviation.
